(19) United States
(12) Patent Application Publication
(10) Pub. No.: US 2022/0225599 A1
(43) Pub. Date: Jul. 21, 2022

(54) TERMITE ATTRACTING DEVICE, INSTALLATION STRUCTURE FOR TERMITE ATTRACTING DEVICE, AND METHOD FOR INSTALLING TERMITE ATTRACTING DEVICE

(71) Applicant: TRUST CO., LTD., Kyoto-shi, Kyoto (JP)

(72) Inventor: Motonobu YAMASHITA, Kyoto-shi, Kyoto (JP)

(21) Appl. No.: 17/615,464

(22) PCT Filed: Jun. 26, 2020
(86) PCT No.: PCT/JP2020/025130

§ 371 Date: Nov. 30, 2021

(30) Foreign Application Priority Data
Sep. 13, 2019 (JP) 2019-166848

(51) Int. Cl. A01M 1/02; A01M 1/20

(52) U.S. Cl. CPC A01M 1/02; A01M 1/2011

(57) ABSTRACT

A termite attracting device including an attracting wood member on the surface of which a soft-rot fungus grows, the soft-rot fungus decaying wood member with a high moisture content from the surface into black-like color, and a cover member including at least a moisture-impermeable layer, with one wood end face of the attracting wood member exposed, the moisture-impermeable layer covering an outer circumferential face of the termite attracting wood member and the other wood end face of the attracting wood member.

### TECHNICAL FIELD

The disclosure relates to a termite attracting device, a structure for installing the termite attracting device, and a method for installing the termite attracting device.

### BACKGROUND ART

Conventionally, various kinds of termite control devices and termite extermination devices are provided in order to prevent damages caused by the termites to the foundation and column of a building.

For example, the following Patent Literature 1 discloses a control method in which an insecticide is injected into a wood piece having a termite attracting property, the wood piece being decayed by a brown decay fungus, and the wood piece is provided on an ant path.

### CITATION LIST

### Patent Literature

PTL 1: Japanese Unexamined Patent Application Publication No.S52-41223

### SUMMARY

### Technical Problem

The wood member decayed by the brown decay fungus is expected to have some attraction effects; however, there is a tendency that cellulose is decomposed by the development of basidiomycetes, the strength of the wood member tends to be significantly reduced from the inside, and the termites no longer like the wood member as bait. In addition, since the wood piece is in an exposed condition, it tends to be easily dried and easily affected by wind or the like, and such an environment is repelled by the termites.

The present invention is achieved in view of the above-mentioned problems and has an object to provide a termite attracting device capable of effectively attracting the termites, a structure for installing the termite attracting device and a method for installing the termite attracting device.

### Solution to Problem

In order to achieve the above-mentioned object, a termite attracting device of one embodiment of the present invention includes an attracting wood member on the surface of which a soft-rot fungus grows, the soft-rot fungus decaying a wood member with a high moisture content from the surface into black-like color, and a cover member including at least a moisture-impermeable layer, with one wood end face of the attracting wood member exposed, the moisture-impermeable layer covering an outer circumferential face of the attracting wood member and the other wood end face of the attracting wood member

In order to achieve the above-mentioned object, a structure for installing the termite attracting device of one embodiment of the present invention is characterized in that the termite attracting device according to one embodiment of the present invention is installed in such a manner that the one wood end face is abutted to an installation target face.

In order to achieve the above-mentioned object, a method for installing the termite attracting device according one embodiment of the present invention is characterized in that the termite attracting device according to one embodiment of the present invention is installed in such a manner that the one wood end face of the attracting wood member is abutted to an installation target face with the outer circumferential face and the other wood end face covered with the cover member after immersing the attracting wood member in water.

### Advantageous Effects of Invention

The termite attracting device, a structure for installing the termite attracting device and a method for installing the termite attracting device according to the embodiments of the present invention are constituted as mentioned above, and the termites are effectively attracted.

### BRIEF DESCRIPTION OF DRAWINGS

FIG. 1A and FIG. 1B diagrammatically illustrate one example of the termite attracting device according to one embodiment of the present invention, FIG. 1A is a schematic front view, and FIG. 1B is a schematic perspective view.

FIG. 2A to FIG. 2C are partially broken schematic front views diagrammatically illustrating one example of the method for installing the termite attracting device according to one embodiment of the present invention.

FIG. 3A and FIG. 3B diagrammatically illustrate one example of the structure for installing the termite attracting device according to one embodiment of the present invention, FIG. 3A is a schematic plan view, and FIG. 3B is a schematic cross-sectional view taken along the arrow X-X in FIG. 2C.

FIG. 4A is a schematic plan view diagrammatically illustrating one example of the structure for installing the termite attracting device, and FIG. 4B is a schematic plan view diagrammatically illustrating one variation of the structure for installing the termite attracting device.

FIG. 5A is a schematic cross-sectional view diagrammatically illustrating one example of the termite attracting device and one example of the structure for installing the termite attracting device corresponding to FIG. 3B according to another embodiment of the present invention, and FIG. 5B is a schematic flow chart diagrammatically illustrating one example of the method for installing the termite attracting device according to another embodiment of the present invention.

### DESCRIPTION OF THE EMBODIMENTS

The embodiments of the present invention are explained referring to the drawings.

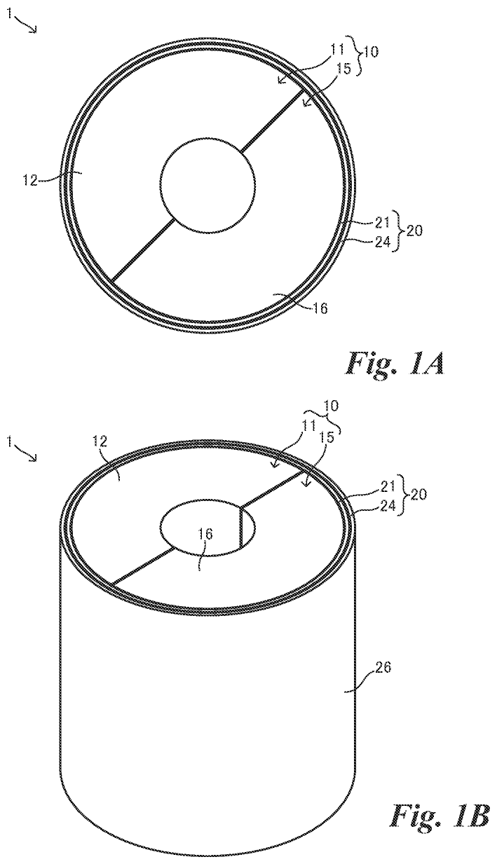

FIG. 1 to FIG. 4 are schematic views illustrating one example of the termite attracting device, one example and one variation of the structure for installing the termite attracting device, and one example of the method for installing the termite attracting device according to the first embodiment.

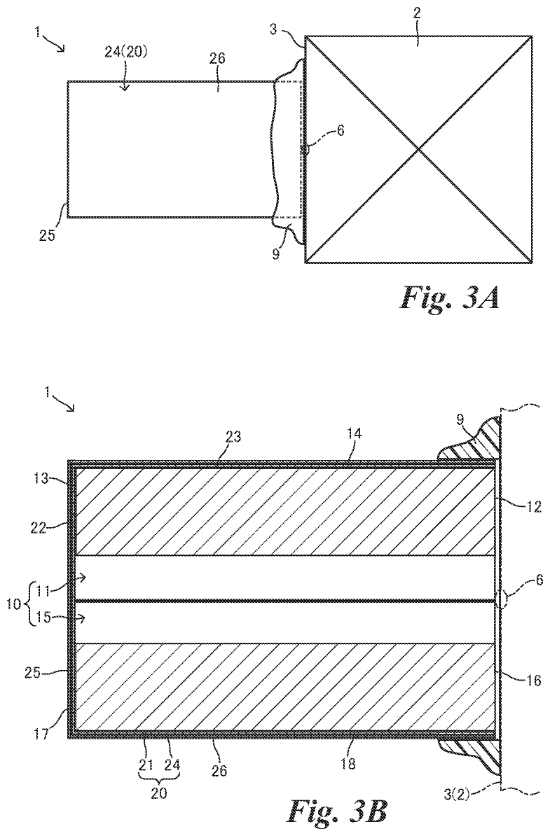

A termite attracting device 1 according to the embodiment, as illustrated in FIG. 1A, FIG. 1B, and FIG. 3B, has an attracting wood member 10 on the surface of which a soft-rot fungus that decays a wood member with a high moisture content from the surface into black-like color grows. In such a configuration, compared with the wood member which is decayed by a white decay fungus or a brown decay fungus in which cellulose or the like is decomposed by the growth of basidiomycetes and the strength of the wood member tends to be significantly reduced from the inside, the strength of the wood member is less likely reduced and decay into the inside of the wood member tends to be slow. Thus, the hardness preferred by the termites is kept for a long time and such a wood member is easily used as a nest. In addition, since it is difficult for hyphae and caps to grow in the wood member, the path formed in the attracting wood member 10 is restrained from being blocked by the growth of hyphae and caps.

The termite attracting device 1 has a cover member 20 including at least a moisture-impermeable layer 21. With the first wood end faces 12, 16 exposed which are faces on one end of the attracting wood member 10, the moisture-impermeable layer 21 covers outer circumferential faces 14, 18 of the attracting wood member 10 and second wood end faces 13, 17 which are faces on the other end of the attracting wood member 10. In such a configuration, when the exposed first wood end faces 12, 16 are provided toward an installation target face 3 provided with an ant path 6 as illustrated in FIG. 3A and FIG. 3B, it is difficult for the attracting wood member 10 to be dried, it is difficult for the inside of the termite attracting device 1 to be affected by wind or the like, and the inside of the termite attracting device 1 is kept in highly humid and sealed environment which is preferred by the termites. When the first wood end faces 12, 16 are provided toward the installation target face 3, the antennae of the termites easily touch the wood end faces which are preferred by the termites and the termites are effectively attracted into the termite attracting device 1.

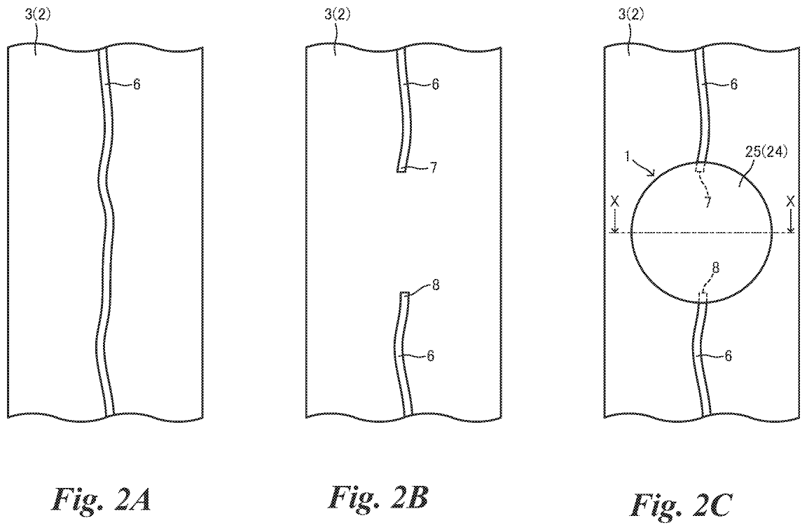

An installation target 2 constituting the installation target face 3 of the termite attracting device 1 can be any members of a building such as a foundation, a pillar, a wall face, and various bases such as a floor base, and a heat insulation material. FIG. 2 exemplifies a pillar elongated in the vertical direction as the installation target 2. The installation target face 3 can constitute one side face of the installation target 2 or can be an approximately flat face. The installation target face 3 is preferably provided at a place where the ant path 6 is formed by the termites.

The termites to be attracted to the termite attracting device 1 can be so-called soil termites such as Reticulitermes and Coptotermes formosanus, dry-wood termites such as Incisitermes minor and Cryptotermes, or any kinds of termites.

The attracting wood member 10 is approximately in the shape of a column. The first wood end faces 12, 16 of the attracting wood member 10 are approximately in the shape of a flat face. The figures exemplify that the second wood end faces 13, 17 are also approximately in the shape of a flat face. The outer circumferential faces 14, 18 of the attracting wood member 10 are in the shape of a curved face around the entire circumference. In the embodiment, the attracting wood member 10 is approximately in the shape of a circular column. As illustrated in FIG. 1A and FIG. 1B, the attracting wood member 10 approximately in the shape of a circular column is constituted with a plurality of attracting wood members, i.e., a first attracting wood member 11 and a second attracting wood member 15. The first attracting wood member 11 and the second attracting wood member 15 are approximately the same in the dimension along the axial direction, i.e., direction from the first wood end faces 12, 16 to the second wood end faces 13, 17. In the embodiment, the first attracting wood member 11 and the second attracting wood member 15 are approximately in the shape of a semicircular column. The figures exemplify that the first attracting wood member 11 and the second attracting wood member 15 are approximately the same in size and shape seen in the axial direction; however, the embodiment is not limited to such an exemplification.

The figures exemplify that a hollow portion penetrating in the axial direction is provided on the axial center approximately in the shape of a circular column, the axial center being formed by abutting the first attracting wood member 11 to the second attracting wood member 15. In such a configuration, the surface area of the first attracting wood member 11 and the second attracting wood member 15 increases. However, such a hollow portion is not always required.

The figures exemplify that the attracting wood member 10 constituted by the first attracting wood member 11 and the second attracting wood member 15 is in the shape of a perfect circle seen in the axial direction and the attracting wood member 10 has the same diameter entirely along the axial direction; however, the embodiment is not limited to such an exemplification. For example, the attracting wood member 10 can be in the shape of an ellipse or approximately in the shape of a polygon seen in the axial direction, and further the attracting wood member 10 can be gradually tapered toward one direction in the axial direction or has a large diameter portion and a small diameter portion in the midway in the axial direction. Further, the attracting wood member 10 can be formed in various shapes.

The dimension in the axial direction and outer diameter of the attracting wood member 10 can be suitably set depending on the installation location and the size of the installation target face 3, or in view of operability, installability, attractivity of the termites, and nesting ability. For example, the dimension of the attracting wood member 10 along the axial direction can be approximately from 50 mm to 300 mm, preferably approximately from 100 mm to 200 mm. The outer diameter of the attracting wood member 10 can be approximately from 30 mm to 150 mm, preferably approximately from 50 mm to 100 mm.

The attracting wood member 10 is a non-repellant wood member that the termites do not repel. Such a non-repellant wood member includes pine, cedar, cherry wood, willow, and aspen, and can be other wood.

The soft-rot fungus which grows on the surface of the attracting wood member 10 decays the wood member with high moisture content, which has difficulty to be decayed by the brown decay fungus or the white decay fungus, from the surface. The soft-rot fungus can be the one which decays the wood member having a moisture content, i.e., a dry basis moisture content, of equal to or larger than 100%, or the one which generally lives in soil. Such a soft-rot fungus can be the one which has lower decomposition power than the white decay fungus or the brown decay fungus and which requires one year or longer to decay the wood member from the surface to the inside, or the core, of the wood member having the outer diameter mentioned above.

The attracting wood member 10 can be the one on which surface the soft-rot fungus grows by immersing the wood member with a high moisture content in water containing the soft-rot fungus. The attracting wood member 10 can be the one on which surface the soft-rot fungus grows by immersing the wood member in water to become the attracting wood member 10 and the decayed wood member obtained in fields and mountains which is decayed by the soft-rot fungus in one container or storage bag. The attracting wood member 10 can be obtained by immersing in the above-mentioned water for several months. The embodiments to obtain the attracting wood member 10 on which surface the soft-rot fungus grows as mentioned above can include many variations.

The cover member 20 includes a light shielding layer 24 in the embodiment. In such a configuration, even when the termite attracting device 1 is provided at a bright place, it is difficult for light which is repelled by the termites to enter the termite attracting device 1 and the inside of the termite attracting device 1 has environment to attract the termites.

The light shielding layer 24 can also function as the moisture-impermeable layer 21 and can also be used as the moisture-impermeable layer 21; however, the light shielding layer 24 is separately provided from the moisture-impermeable layer 21 in the embodiment.

The moisture-impermeable layer 21 is configured so as not to pass moisture or is configured to have difficulty in passing moisture. The moisture-impermeable layer 21 is preferably an air-impermeable layer which does not pass air or has difficulty in passing air in addition to moisture.

The moisture-impermeable layer 21 includes an end-face covering portion 22 to cover the second wood end faces 13, 17 of the attracting wood member 10 and an outer-circumference covering portion 23 to cover the outer circumferential faces 14, 18 of the attracting wood member 10. The moisture-impermeable layer 21 and the outer circumferential faces 14, 18 of the attracting wood member 10 can be provided so as to have a slight gap (about 1 mm to 3 mm) therebetween or in a closely contacted manner so as to have a gap less than 1 mm therebetween.

The moisture-impermeable layer 21 is transparent. The transparent degree of the moisture-impermeable layer 21 is sufficient as long as the inside of the termite attracting device 1 is visually recognized or existence of the termites is confirmed through the moisture-impermeable layer 21. The moisture-impermeable layer 21 can be colored transparent or semitransparent.

The moisture-impermeable layer 21 can be made from, for example, a transparent synthetic resin material such as polyvinylidene chloride, polyethylene terephthalate, polycarbonate, or acrylic resin. The moisture-impermeable layer 21 can be in the form of a film. In such a case, part of or the entire of the end-face covering portion 22 and the outer-circumference covering portion 23 which constitute the moisture-impermeable layer 21 can be formed in a plurality of layers. The moisture-impermeable layer 21 can be in the shape of a bottomed tubular container opening in one direction in which the tubular outer-circumference covering portion 23 is provided in a series toward one direction in the axial direction from the outer circumferential edge portion of the end-face covering portion 22 in the form of a sheet or a plate. Further, the moisture-impermeable layer 21 can be configured in various manners. The gap formed between the outer-circumference covering portion 23 of the moisture-impermeable layer 21 and the outer circumferential faces 14, 18 of the attracting wood member 10 can be filled with a transparent gel material or the like which is not repelled by the termites.

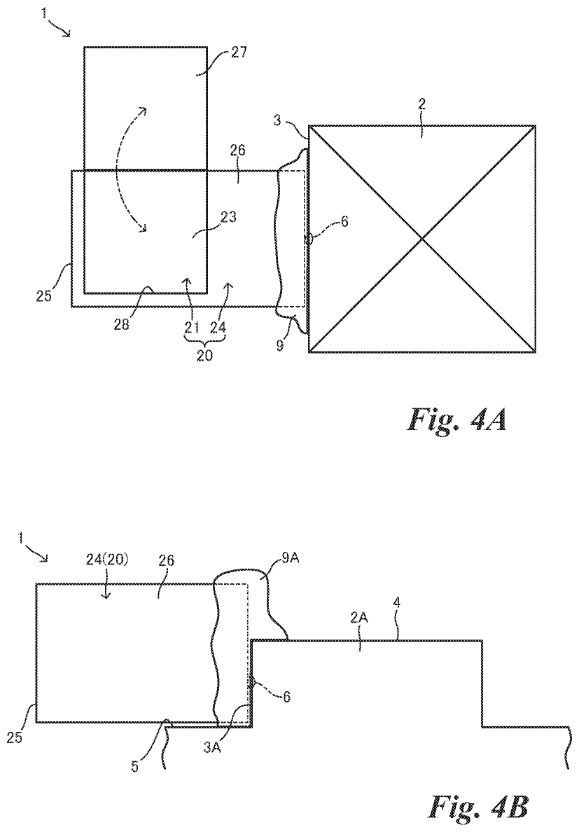

The light shielding layer 24 is configured not to allow transmission of light or is configured to have difficulty in transmitting light. The light shielding layer 24 is provided on the outer circumferential side of the moisture-impermeable layer 21 in the embodiment. As illustrated in FIG. 4A, the light shielding layer 24 includes an opening 28 through which the inside of the termite attracting device 1 is visually recognized and a lid portion 27 to open or close the opening 28 when the termite attracting device 1 is installed. In such a configuration, the inside of the termite attracting device 1 is confirmed without removing the termite attracting device 1 from the installation target 2. The light shielding layer 24 is provided on the outer circumferential side of the transparent moisture-impermeable layer 21, so that it is difficult for outside air or the like to enter the termite attracting device 1 when the inside of the termite attracting device 1 is checked. Therefore, even when the termites exist in the termite attracting device 1, it is difficult for such a configuration to impart stress to the termites and restrains the termites from being cautious.

The light shielding layer 24 has an end-face covering portion 25 provided so as to cover the outside of the end-face covering portion 22 of the moisture-impermeable layer 21, i.e., the outside of the attracting wood member 10 in the axial direction, and an outer-circumference covering portion 26 provided so as to cover the outer circumference of the outer-circumference covering portion 23 of the moisture-impermeable layer 21. The light shielding layer 24 and the moisture-impermeable layer 21 can have a slight gap (about 1 mm to 3 mm) therebetween or can be in a closely contacted manner so as to have a gap less than 1 mm therebetween.

The light shielding layer 24 can be made of a metallic material such as aluminum or a synthetic resin material containing pigments with high light shielding ability. The light shielding layer 24 can be in the form of a film, i.e., a foil, and, for example, can be made from an aluminum foil. In such a case, similar to the above, part of or the entire of the end-face covering portion 25 and the outer-circumference covering portion 26 which constitute the light shielding layer 24 can be formed in a plurality of layers.

When the light shielding layer 24 is made of an aluminum foil or the like, part of which is easily peeled off and covered again, the opening 28 can be formed by peeling off part of the aluminum foil or the peeled portion is formed as the lid portion 27. The figures exemplify that part of the outer-circumference covering portion 26 of the light shielding layer 24 is peeled off in a cantilever manner to form the lid portion 27 and the opening 28 is provided; however, the embodiment is not limited to such an exemplification. The lid portion 27 is not limited to be freely opened or closed like a hinged door without peeling off the part thereof relative to the outer-circumference covering portion 26, and can be detachable to the outer-circumference covering portion 26.

The light shielding layer 24 can be in the shape of a bottomed tubular container opening in one direction in which the tubular outer-circumference covering portion 26 is provided in a series toward one direction in the axial direction from the outer circumferential edge portion of the end-face covering portion 25 in the form of a sheet or a plate, in place of the above-mentioned embodiment. In such a case, for example, the lid portion 27 for opening or closing the opening 28 provided for part of the outer-circumference covering portion 26 can be separately provided. Also in such a case, the lid portion 27 can be provided for the outer-circumferential covering portion 26 slidably or rotatably, or detachably. Further, the light shielding layer 24 can have various configurations. The cover member 20 is not limited to one with the moisture-impermeable layer 21 and the light shielding layer 24 which are separately provided, and the light shielding layer 24 can be also used as the moisture-impermeable layer 21. When the installation position of the termite attracting device 1 is dark, the cover member 20 can be configured not to include the light shielding layer 24. Further, the cover member 20 can have various configurations. A cover portion to detachably cover the first wood end faces 12, 16 side can be provided in order not to dry the attracting wood member 10 in the process of commodity circulation of the termite attracting device 1.

The termite attracting device 1 configured as mentioned above can be installed to be mentioned below, for example.

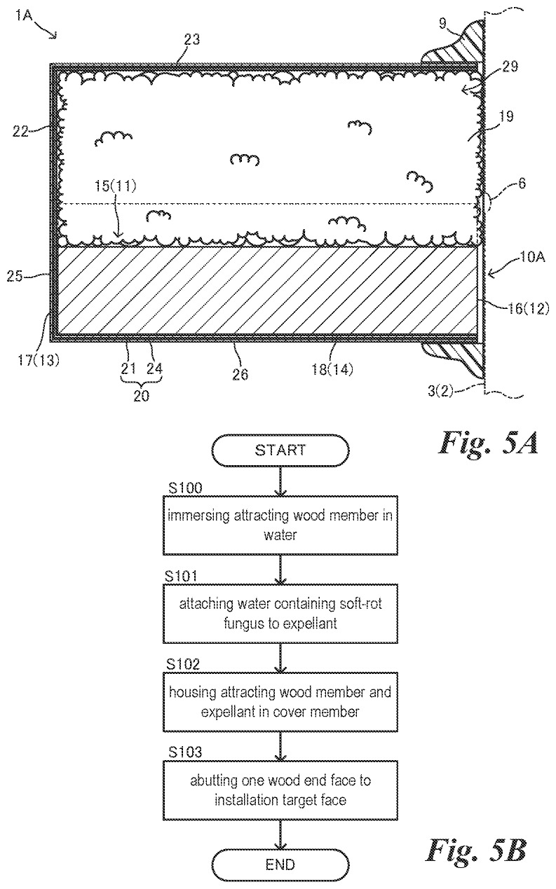

After immersing the attracting wood member 10 in water, with the outer circumferential faces 14, 18 and the second wood end faces 13, 17 covered by the cover member 20, the first wood end faces 12, 16 of the attracting wood member 10 can be abutted to the installation target face 3, referring to step S100 and step S103 in FIG. 5B. In such a configuration, the attracting wood member 10 effectively has a high moisture content and the inside of the installed termite attracting device 1 is effectively made in a highly humid atmosphere. The time for immersing the attracting wood member 10 in water can be about several minutes, about several hours, or about several days. In place of an embodiment in which the attracting wood member 10 is immersed in water, the attracting wood member 10 can be sprayed with water by a suitable spraying device, or the attracting wood member 10 can be installed in a covered condition with the cover member 20 without supplying water before installation since the original wood member has a high moisture content as mentioned above.

The termite attracting device 1 installed as mentioned above is configured such that the first wood end faces 12, 16 abut to the installation target face 3.

Before installing the termite attracting device 1 as mentioned above, part of the ant path 6 is removed as illustrated in FIG. 2A and FIG. 2B, and the termite attracting device 1 can be installed so as to cross the first end portion 7 and the second end portion 8 on the removed side as illustrated in FIG. 2C. In such a configuration, the antennae of the termites which pass the ant path 6 and come out the removed portion are effectively made to contact with the first wood end faces 12, 16 of the attracting wood member 10. The dimension of the removed ant path 6 can be smaller than that of the inner diameter of the cover member 20 in such a manner that the first end portion 7 and the second end portion 8 on the removed side are housed in the cover member 20.

When the attracting wood member 10 is overlapped on the first end portion 7 and the second end portion 8 of the ant path 6, as illustrated in FIG. 3B, a slight gap can be formed between the first wood end faces 12, 16 of the attracting wood member 10 and the installation target face 3, the gap can be equal to or less than 3 mm, or preferably equal to or less than 2 mm. A concave portion to receive the first end portion 7 and the second end portion 8 of the ant path 6 can be provided for the first wood end faces 12, 16 of the attracting wood member 10 so as to make it difficult to form such a gap.

The figures exemplify that part of the ant path 6 is formed on the installation target 2; however, the embodiment is not limited to such an exemplification. The figures exemplify that the termite attracting device 1 is installed so as to coincide the approximate axial center of the attracting wood member 10 with the place where the ant path 6 was provided; however, the embodiment is not limited to such an exemplification.

As illustrated in FIG. 3A and FIG. 3B, a paste-like sealing member 9 can be adhered to the installation target face 3 along the circumferential edge portion on the opening side so as to seal the opening side of the cover member 20. Such an installation achieves a configuration that the paste-like sealing member 9 adheres to the installation target face 3 along the circumferential edge portion on the opening side so as to seal the opening side of the cover member 20. In such a configuration, the sealing degree in the termite attracting device 1 is improved by a simple configuration. When the termite attracting device 1 is configured to be fixed to the installation target face 3 by the sealing member 9, compared with a configuration in which the termite attracting device 1 is fixed with screws or nails, the termite attracting device 1 is easily installed and positioning is facilitated.

The sealing member 9 is moisture impermeable and has a light shielding effect. The sealing member 9 can be non-dry and a so-called seal putty. In such a configuration, adherence is easily and relatively surely executed with hands depending on the installation target face 3 and the outer circumferential shape of the termite attracting device 1. And the termite attracting device 1 is removed in a relatively easy manner.

The sealing member 9 can contain a termite proofing agent so as not to be fed by the termites. The sealing member to seal the opening side of the cover member 20 can be a suitable sealing tape such as an adhesive tape, or a sealing member, i.e., a calking member, which is discharged by a calking gun, in place of the paste-like sealing member 9. Further, without providing such a sealing member, the termite attracting device 1 can be fixed to the installation target face 3 with screws or nails in a closely contacted manner.

Although FIG. 3A, FIG. 3B and FIG. 4A exemplify that the termite attracting device 1 is installed for the installation target face 3 of which width is larger than the outer diameter of termite attracting device 1; the termite attracting device 1 can be installed for an installation target face 3A of which width is smaller than the outer diameter of the termite attracting device 1 as illustrated in FIG. 4B. FIG. 4B exemplifies that the termite attracting device 1 is installed along an internal corner portion of the installation target face 3A of an installation target 2A and an adjacent face 5 provided so as to be orthogonal to the installation target face 3A. In such a case, it can be configured such that part of the first wood end faces 12, 16 of the attracting wood member 10 is abutted so as to be positioned corresponding to the ant path 6 of the installation target face 3A and a sealing member 9A is provided so as to cover the other region of the first wood end faces 12, 16 which are not abutted to the installation target face 3A. The figure exemplifies that the sealing member 9A is provided so as to adhere also to the other face 4 of the installation target 2A orthogonal to the installation target face 3A.

The other region of the first wood end faces 12, 16 which is not abutted to the installation target face 3A can be configured to be covered by other sealing members, a lid portion, or the like.

The installation embodiment of the termite attracting device 1 is not limited to the embodiments mentioned above and various embodiments are applicable depending on the shape of the installation target faces 3, 3A and the installation position where the ant path 6 is provided. A plurality of termite attracting devices 1 can be provided at intervals along the longitudinal direction of the ant path 6.

Next explained are another embodiment of the termite attracting device, the structure for installing the termite attracting device, and the method for installing the termite attracting device according to one aspect of the present invention, referring to FIG. 5.

In the following embodiment, the difference from the embodiment explained above is mainly explained, the similar configurations are allotted with the same reference numerals and their explanations are omitted or briefly explained. The effect which is similar to those of the embodiments mentioned above is omitted or simply explained.

FIG. 5A and FIG. 5B are schematic views illustrating one example of the termite attracting device according to the second embodiment, one example of the structure for installing the termite attracting device, and one example of the method for installing the termite attracting device.

In the embodiment, as illustrated in FIG. 5A, a storage space 29 for storing an expellant 19 containing a slow acting termiticidal agent is provided in a termite attracting device 1A. In such a configuration, when the termite attracting device 1A is installed with the expellant 19 housed in the storage space 29, the termites are effectively attracted, so that the termites are effectively made to take in the expellant 19.

In the embodiment, an attracting wood member 10A is constituted by only one (the second attracting wood member 15 in the figures) of the first attracting wood member 11 and the second attracting wood member 15 constituting the attracting wood member 10 of the termite attracting device 1 of the first embodiment, and the residual space covered by the cover member 20 constitutes the storage space 29. The storage space 29 opens in one direction along the axial direction of the termite attracting device 1A and is defined by the cover member 20 and the second attracting wood member 15. In place of such an embodiment, the above-mentioned hollow portion can constitute the storage space 29 to store the expellant 19, and the storage space 29 can be configured in various manners.

The expellant 19 can be bait containing a termiticidal component with slow acting property; thus a worker ant reached the termite attracting device 1 takes the expellant 19, returns to a nest without dying immediately, and shares the expellant 19 to be taken in other termites. The expellant 19 can be produced in such a manner that growth inhibitor impeding molting of the termites such as bistrifluron and Nova Furmron is injected or impregnated as an effective component, into a cellusic base material as bait material such as a wood member and paper or is mixed with wood flour. Such expellant 19 can be a commercially available one as a so-called bait agent. The expellant 19 is preferably filled in the storage space 29 via a slight gap mentioned above with the cover member 20 and the second attracting wood member 15 defining the storage space 29 or so as to closely contact with the cover member 20 and the second attracting wood member 15. The expellant 19 is preferably filled in the storage space 29 via a slight gap mentioned above with the installation target face 3 or so as to closely contact with the installation target 3. The expellant 19 can be constituted in various manners.

The termite attracting device 1A as configured above can be installed to be mentioned below as illustrated in FIG. 5B.

Similar to the above-mentioned first embodiment, the attracting wood member 10A (the second attracting wood member 15) is immersed in water (step S100). Then, the expellant 19 and the attracting wood member 10A can be housed in the cover member 20 with the expellant 19 attached with water containing the above-mentioned soft-rot fungus, and the first wood end face 16 of the attracting wood member 10A can be abutted to the installation target face 3 (steps S101 to S103). In such a configuration, the soft-rot fungus which attracts the termites is attached on the expellant 19, so that the termites are effectively attracted to take the expellant 19.

For attaching water containing the soft-rot fungus to the expellant 19, the expellant 19 can be immersed in water containing the soft-rot fungus or water containing the soft-rot fungus can be sprayed to the expellant 19. The expellant 19 is not always required to be attached with water containing the soft-fungus. The expellant 19 and the attracting wood member 10A can be simultaneously housed in the cover member 20, or one of them can be housed at first and the other can be housed later.

Like the first embodiment mentioned above, the paste-like sealing member 9 can adhere to the installation target face 3 along the circumferential edge portion on the opening side so as to seal the opening side of the cover member 20.

The termite attracting devices 1, 1A, the structure for installing the termite attracting device, and the method for installing the termite attracting device explained in above-mentioned each embodiment are only one example and many variations are applicable.

### REFERENCE SIGNS LIST

1, 1A termite attracting device

10, 10A attracting wood member

12, 16 first wood end face (one wood end face)

13, 17 second wood end face (the other wood end face)

14, 18 outer circumferential face

19 expellant

20 cover member

21 moisture-impermeable layer

24 light shielding layer

27 lid portion

28 opening

29 storage space

3, 3A installation target face

9, 9A seal member

1. A termite attracting device comprising:
an attracting wood member on the surface of which a soft-rot fungus grows, the soft-rot fungus decaying a wood member with a high moisture content from the surface into black-like color; and
a cover member including at least a moisture-impermeable layer, with one wood end face of the attracting wood member exposed, the moisture-impermeable layer covering an outer circumferential face of the attracting wood member and the other wood end face of the attracting wood member.

2. The termite attracting device according to claim 1,
wherein the cover member comprises a light shielding layer.

3. The termite attracting device according to claim 2,
wherein the cover member comprises the light shielding layer on an outer circumferential side of the moisture-impermeable layer being transparent, and
wherein the light shielding layer is provided with an opening through which inside of the termite attracting device is visually recognized and a lid portion to open or close the opening with the termite attracting device installed.

4. The termite attracting device according to claim 1,
wherein the termite attracting device is provided with a storage space for storing an expellant containing a slow acting termiticidal agent.

5. A structure for installing the termite attracting device according to claim 1,
wherein the termite attracting device is installed in such a manner that the one wood end face is abutted to an installation target face.

6. The structure for installing the termite attracting device according to claim 5,
wherein a paste-like sealing member is adhered to the installation target face along a circumferential edge portion on an opening side so as to seal the opening side of the cover member.

7. A method for installing the termite attracting device according to claim 1,
wherein the one wood end face of the attracting wood member is abutted to an installation target face with the outer circumferential face and the other wood end face covered with the cover member after immersing the attracting wood member in water.

8. The method for installing the termite attracting device according to claim 4,
wherein the expellant is housed in the storage space with the expellant attached with water containing the soft-rot fungus, and the one wood end face of the attracting wood member is abutted to an installation target face.

9. The termite attracting device according to claim 2,
wherein the termite attracting device is provided with a storage space for storing an expellant containing a slow acting termiticidal agent.

10. The termite attracting device according to claim 3,
wherein the termite attracting device is provided with a storage space for storing an expellant containing a slow acting termiticidal agent.

11. A structure for installing the termite attracting device according to claim 2,
wherein the termite attracting device is installed in such a manner that the one wood end face is abutted to an installation target face.

12. A structure for installing the termite attracting device according to claim 3,
wherein the termite attracting device is installed in such a manner that the one wood end face is abutted to an installation target face.

13. A structure for installing the termite attracting device according to claim 4,
wherein the termite attracting device is installed in such a manner that the one wood end face is abutted to an installation target face.

14. A structure for installing the termite attracting device according to claim 9,
wherein the termite attracting device is installed in such a manner that the one wood end face is abutted to an installation target face.

15. A structure for installing the termite attracting device according to claim 10,
wherein the termite attracting device is installed in such a manner that the one wood end face is abutted to an installation target face.

16. A method for installing the termite attracting device according to claim 2,
wherein the one wood end face of the attracting wood member is abutted to an installation target face with the outer circumferential face and the other wood end face covered with the cover member after immersing the attracting wood member in water.

17. A method for installing the termite attracting device according to claim 3,
wherein the one wood end face of the attracting wood member is abutted to an installation target face with the outer circumferential face and the other wood end face covered with the cover member after immersing the attracting wood member in water.

18. A method for installing the termite attracting device according to claim 4,
wherein the one wood end face of the attracting wood member is abutted to an installation target face with the outer circumferential face and the other wood end face covered with the cover member after immersing the attracting wood member in water.

19. A method for installing the termite attracting device according to claim 9,
wherein the expellant is housed in the storage space with the expellant attached with water containing the soft-rot fungus, and the one wood end face of the attracting wood member is abutted to an installation target face after immersing the attracting wood member in water.

20. A method for installing the termite attracting device according to claim 10,
wherein the expellant is housed in the storage space with the expellant attached with water containing the soft-rot fungus, and the one wood end face of the attracting wood member is abutted to an installation target face after immersing the attracting wood member in water.
